(19) United States
(12) Patent Application Publication
(10) Pub. No.: US 2007/0183124 A1
(43) Pub. Date: Aug. 9, 2007

(54) COMPUTER CHASSIS

(76) Inventors: Shih-Hsun Wung, Shenzhen (CN); Chun-Chi Chen, Shenzhen (CN); Tsung-Lung Lee, Shenzhen (CN); Bao-Chun Chen, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/307,445

(22) Filed: Feb. 8, 2006

(51) Int. Cl. G06F 1/16

(52) U.S. Cl. 361/683

(57) ABSTRACT

A computer chassis compatible with an ATX motherboard and a BTX motherboard, includes a motherboard holder (100) for mounting an ATX motherboard or a BTX motherboard thereon, a first back panel (200) designed for the ATX motherboard, and a second back panel (300) designed for the BTX motherboard. A side panel (840) is located opposite the motherboard holder, defining a plurality of vents (842) in a lower portion of the side panel. The motherboard holder, the first and second back panels are available in two arrangements to make the computer chassis in accordance with the preferred embodiment of the present invention to be adapted to the ATX motherboard or the BTX motherboard.

### FIELD OF THE INVENTION

The present invention relates generally to a computer chassis, and more particularly to a computer chassis compatible with an ATX motherboard and a BTX motherboard.

### DESCRIPTION OF RELATED ART

A computer usually has a computer chassis that may hold a motherboard, a power supply and multiple printed circuit boards (PCBs) such as a graphic card, a sound card and a network card.

A motherboard mounted to the computer chassis usually has electronic components such as electric capacities, slots for Random Access Memories (RAM), a socket for a central processing unit (CPU) mounted on the motherboard. Motherboards are available in several standards such as an advanced technology extended (ATX) standard and a micro-ATX standard depending on arrangements of the electronic components on the motherboards. ATX motherboards are applied to most computers nowadays.

With reference to FIG. 13, a conventional computer chassis compatible with ATX motherboards comprises a motherboard holder 10 and a back panel 20. The back panel 20 is mounted on the motherboard holder 10. A rectangular window 22 is defined through the back panel 20 close to a top edge thereof. An opening 24 is defined through the back panel 20 under the rectangular window 22 and adjacent to the motherboard holder 10. A plurality of vents 26 is defined through the back panel 20 under the rectangular window 22 and adjacent to the opening 24. A plurality of slots 28 is defined through the back panel 20 close to a bottom edge thereof under the opening 24 and the vents 26. The arrangement of the rectangular window 22, the opening 24, the vents 26 and the slots 28 of the back panel 20 is aimed at an ATX motherboard.

The arrangement of electronic components on a motherboard is redesigned to be adapted to a new computer hardware and to improve the performance of the motherboard, as well as setting a balanced technology extended (BTX) standard for motherboards. The arrangement of electronic components on a BTX motherboard is opposite to the arrangement of electronic components on an ATX motherboard. The back panel 20 of the conventional computer chassis is incompatible with the BTX motherboard. Therefore, computer chassis manufacturers manufacturing the conventional computer chassis have to manufacture BTX computer chassis additionally for BTX motherboards. However, computer hardware develops very rapidly, and BTX motherboards are becoming very popular. It is predictable that ATX motherboards will be unmarketable soon and the computer chassis manufacturers will incur significant losses due to the obsolete conventional computer chassis, especially to ATX motherboard.

What is needed, therefore, is a computer chassis which is compatible with an ATX motherboard and a BTX motherboard and which can have better heat dissipation effectiveness for electronic component received in the computer chassis.

### SUMMARY OF INVENTION

A computer chassis compatible with an ATX motherboard and a BTX motherboard, comprises a motherboard holder for mounting an ATX motherboard or a BTX motherboard thereon, a first back panel designed for the ATX motherboard, and a second back panel designed for the BTX motherboard. The motherboard holder, the first and second back panels are available in two arrangements to make the computer chassis in accordance with the preferred embodiment of the present invention to be adapted to the ATX motherboard or the BTX motherboard.

Other advantages and novel features will become more apparent from the following detailed description of preferred embodiments when taken in conjunction with the accompanying drawings, in which:

### BRIEF DESCRIPTION OF DRAWINGS

FIG. 1 is a perspective view of a computer chassis in accordance with a preferred embodiment of the present invention which is compatible with an ATX motherboard;

FIG. 2 is an exploded view of the computer chassis of FIG. 1;

FIG. 3 is an enlarged perspective view of a first back panel of FIG. 2;

FIG. 4 is an enlarged view of a mounting board, a locking member and a retainer of FIG. 2;

FIG. 5 is an enlarged view of the retainer of FIG. 4, viewed from another aspect;

FIG. 6 is an enlarged, assembled view of the first back panel and the retainer of FIG. 2;

FIG. 7 is a view similar to FIG. 3, but viewed from a different aspect;

FIG. 8 is an assembled view of the first back panel and a plurality of expansion cards;

FIG. 9 is an enlarged view of a circled portion of FIG. 8;

FIG. 10 is a perspective view of a computer chassis in accordance with a preferred embodiment of the present invention which is compatible with a BTX motherboard;

FIG. 11 is an exploded view of the computer chassis of FIG. 10;

FIG. 12 is a partially assembled view of a computer enclosure formed by the computer chassis of FIG. 1 together with another four panels; and

FIG. 13 is a perspective view of a conventional computer chassis compatible with ATX motherboards.

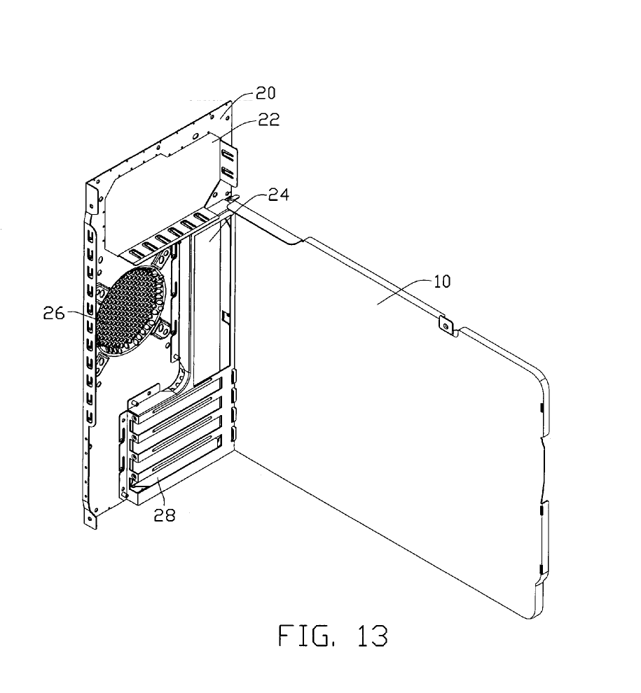

### DETAILED DESCRIPTION

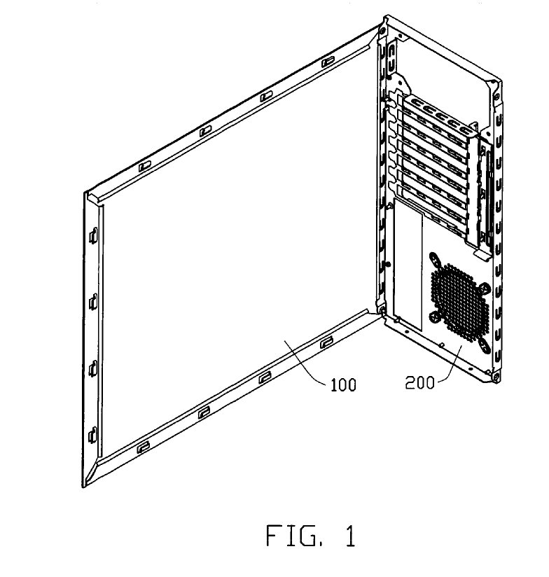

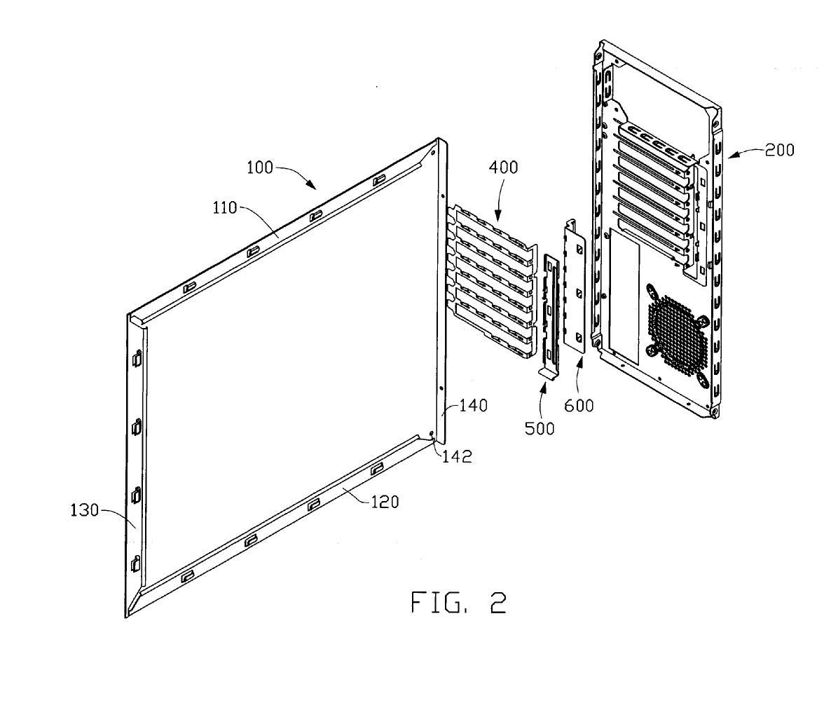

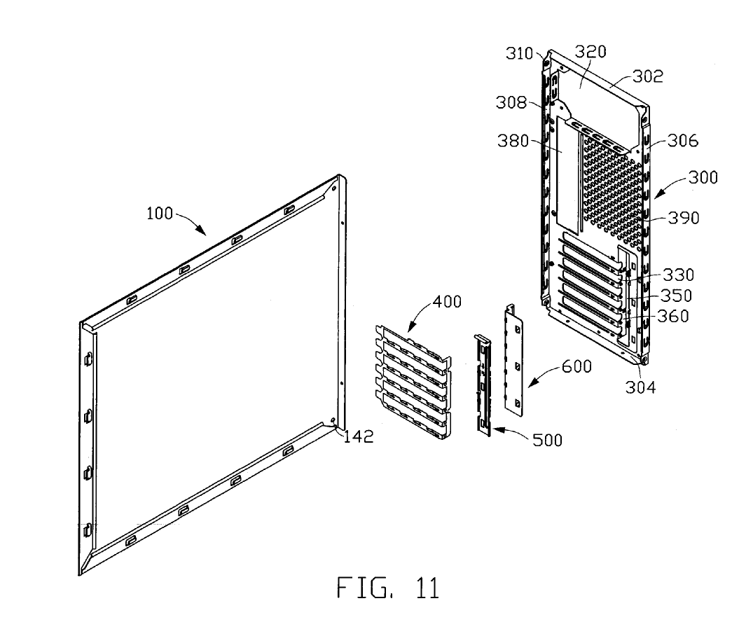

Referring to FIGS. 1-2 and 10-11, a computer chassis in accordance with a preferred embodiment of the present invention comprises a motherboard holder 100, a first back panel 200, a second back panel 300, a mounting cover 400, a locking member 500 and a retainer 600.

The motherboard holder 100 is used for holding an ATX motherboard (not shown) or a BTX motherboard (not shown) thereon. The motherboard holder 100 comprises a top flange 110, a bottom flange 120, a front flange 130 and a back flange 140. A pair of mounting bores 142 is defined through the motherboard holder 100, and is adjacent to two opposite ends of the back flange 140.

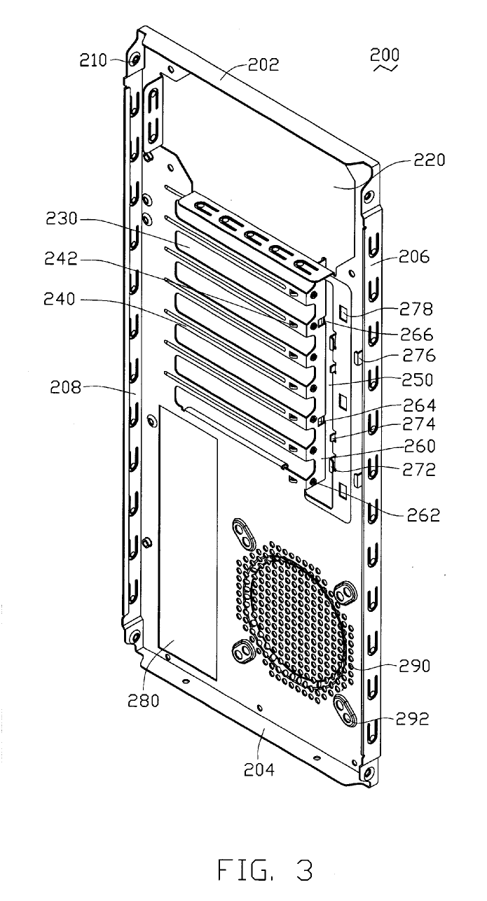

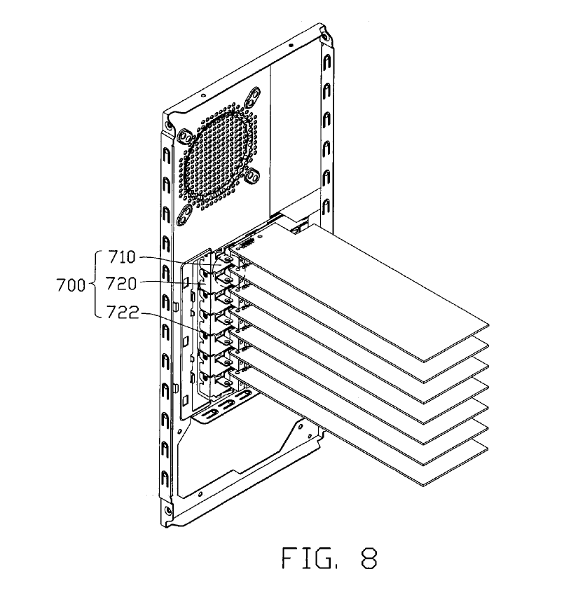

Referring also to FIG. 3, the first back panel 200 comprises a top edge 202, a bottom edge 204, a right side edge 206 and a left side edge 208. The left side edge 208 comprises a pair of mounting bores 210 aligned with corresponding mounting bores 142 of the motherboard holder 100 for screwing and fixing the first back panel 200 to the motherboard holder 100. A rectangular window 220 is defined through the first back panel 200 close to the top edge 202 thereof and provided for mounting a power supply thereto. A plurality of parallel first slots 230 is defined through the first back panel 200 under the rectangular window 220 and adjacent to the motherboard holder 100. The first slots 230 are spaced apart at uniform intervals for providing access to and receiving expansion cards 700 (shown in FIG. 8). A plurality of first walls 240 is formed between adjacent first slots 230. A triangular protrusion 242 is formed on each first wall 240 near the right side edge 206. An elongated slot 250 is longitudinally defined in the first back panel 200 between the triangular protrusions 242 and the right side edge 206, adjacent to right ends of the first slots 230, and in communication with the first slots 230. A fixing plate 260 perpendicularly and rearwards extends from a right lateral edge of the first walls 240, between the first slots 230 and the elongate slot 250. The fixing plate 260 comprises a plurality of nubs 262 formed on a surface thereof, and a pair of spaced apertures 264 defined in a rear side thereof to form two pivot shafts 266 thereon. A pair of first bent tabs 272 is formed adjacent to a right lateral edge of the elongated slot 250, and a pair of positioning protrusions 274 is formed between the first bent tabs 272. A pair of second bent tabs 276 aligned with the corresponding first bent tabs 272, respectively, extends from the first back panel 200 proximate to the right side edge 206 thereof. The bent tabs 272, 276 are bent toward each other. Three spaced through holes 278 are defined through the first back panel 200 and located between the first and second bent tabs 272, 276. An opening 280 is defined through the first back panel 200 under the first slots 230 and adjacent to the motherboard holder 100. The opening 280 is used for mounting I/O connectors (not shown) mounted on a motherboard or a printed circuit board for connecting with other computer peripherals. A plurality of vents 290 is defined through the first back panel 200 close to the bottom edge 204 thereof and adjacent to the opening 280. A plurality of mounting holes 292 is symmetrically defined around the vents 290 for mounting a fan (not shown) thereon. Therefore, the rectangular window 220 is defined in an upper portion of the first back panel 200, the opening 280 and the vents 290 are located at a bottom portion of the first back panel 200, and the first slots 230 with associated elements such as elongated slot 250 are located at a middle portion of the first back panel 200. The arrangement of the rectangular window 220, the first slots 230, the opening 280 and the vents 290 of the first back panel 200 is aimed at the ATX motherboard.

The second back panel 300 has a similar shape to that of the first back panel 200. The second back panel 300 also comprises a top edge 302, a bottom edge 304, a right side edge 306 and a left side edge 308. The left side edge 308 of the second back panel 300 also comprises a pair of mounting bores 310 aligned with corresponding mounting bores 142 of the motherboard holder 100 for screwing and fixing the second back panel 300 to the motherboard holder 100. The second back panel 300 also comprises an upper portion, a middle portion and a bottom portion. The upper portion of the second back panel 300 is the same as that of the first back panel 200. The bottom portion of the second back panel 300 is the same as the middle portion of the first back panel 200. The middle portion of the second back panel 300 is similar to the bottom portion of the first back panel 200. The only difference between the middle portion of the second back panel 300 and the bottom portion of the first back panel 200 is that the vents 390 of the second back panel 300 are arranged to form a matrix configuration, while the vents 290 of the first back 200 panel are arranged to form a round configuration. Moreover, the opening 280 of the first back panel 200 is located in the bottom portion thereof, while the opening 380 of the second back panel 300 is located in the middle portion thereof. The first and second back panels 200, 300 have same elements such as rectangular windows 220, 320, the first slots 230, 330, the fixing plates 260, 360, the openings 280, 380 and the vents 290, 390, and so on; the main difference therebetween is that theses elements are located at different places in the first and second back panels 200, 300. Therefore, in following descriptions, descriptions referred to the elements of the first back panel 200 are also applicable to the corresponding elements of the second back panel 300. The arrangement of the rectangular window 320, the first slots 330, the opening 380 and the vents 390 of the second back panel 300 is aimed at the BTX motherboard.

The mounting cover 400 is used for mounting expansion cards 700 to the computer chassis in accordance with the preferred embodiment of the present invention.

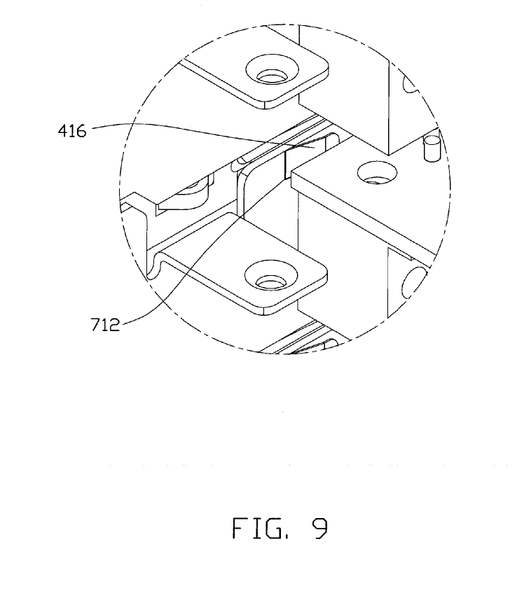

Referring to FIGS. 8-9, each expansion card 700 has an elongated slot cover 710, a head 720, and a tapered tail (not shown). The head 720 extends perpendicularly from an end of the slot cover 710. A U-shaped pit 722 is defined in an upper edge of the head 720, and aligned with a corresponding nub 262 of the fixing plate 260. A plurality of splits 712 is defined in a bottom edge of the slot cover 710.

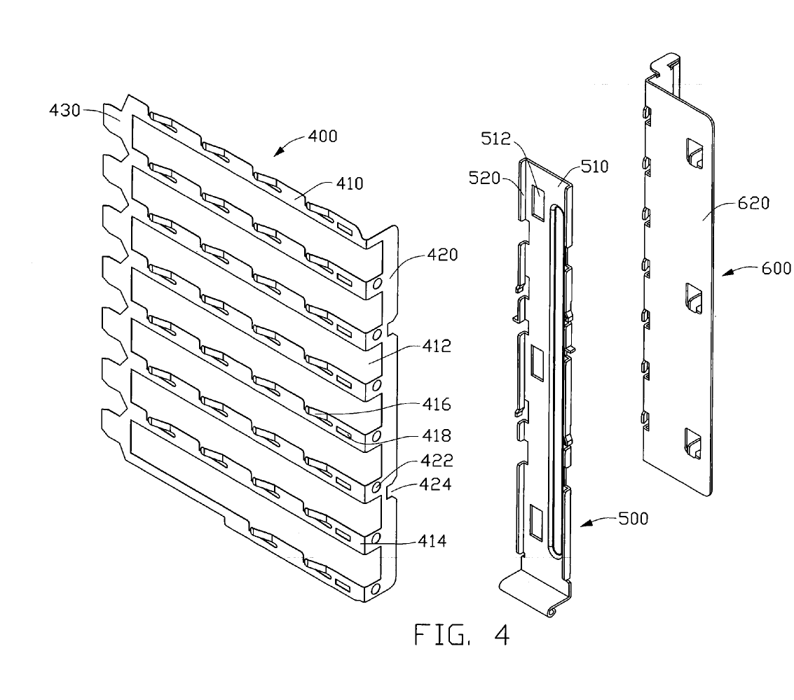

Referring also to FIG. 4, the mounting cover 400 comprises a body 410, a bent portion 420 perpendicularly extending from a right side of the body 410, and a plurality of tapered tail portions 430 formed on a left side of the body 410, and coplanar with the body 410. The body 410 comprises a plurality of second slots 412 and a plurality of second walls 414 aligned with the corresponding first slots 230 and first walls 240 of the first back panel 200, respectively. Each second wall 414 comprises a plurality of elastic arms 416 formed on an upper edge thereof for being retainingly received in the associated splits 712 of the slot cover 710 (clearly shown in FIG. 9). A notch 418 is defined in each second wall 414 and adjacent to the bent portion 420 for receiving the associated triangular protrusion 242. A plurality of holes 422 is formed at an edge of the bent portion 420, and adjacent to the body 410 for receiving the associated nubs 262 of the fixing plate 260. A pair of spaced cutouts 424 is defined in a rear edge of the bent portion 420.

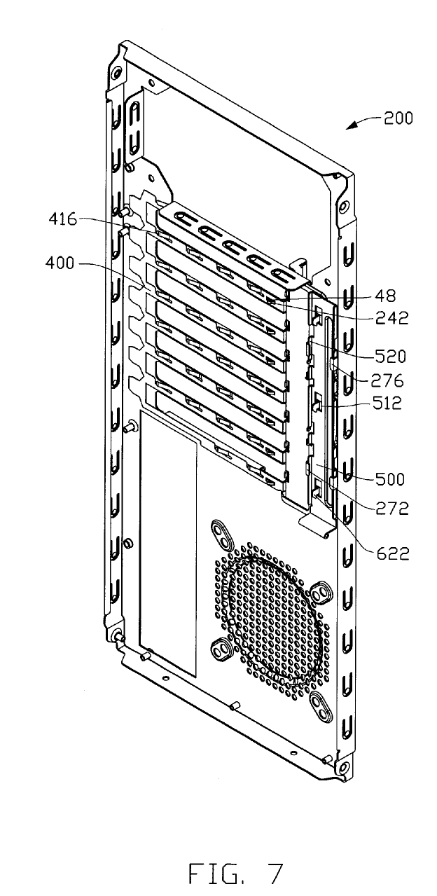

Referring to FIG. 4 and FIG. 7, the locking member 500 is detachably mounted to the first back panel 200. The locking member 500 comprises a board 510, a plurality of flanges 520 perpendicularly extending from opposite sides of the board 510. Some of the flanges 520 are aligned with the first and second bent tabs 272, 276 of the first back panel 200, respectively. The first and second bent tabs 272, 276 abut against these flanges 520, respectively. Two of the flanges 520 are aligned with the positioning protrusions 274 of the first back panel 200 respectively, for being positioned to a right place. Three spaced orifices 512 are defined through the board 510, and aligned with the corresponding through holes 278 of the first back panel 200, respectively.

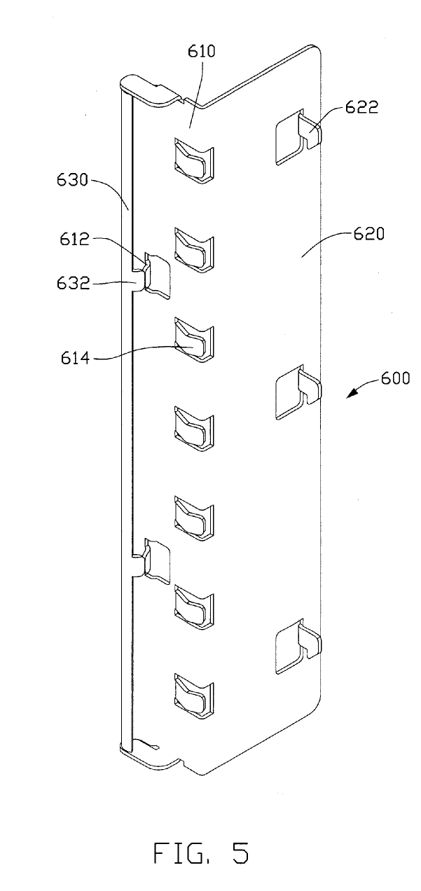

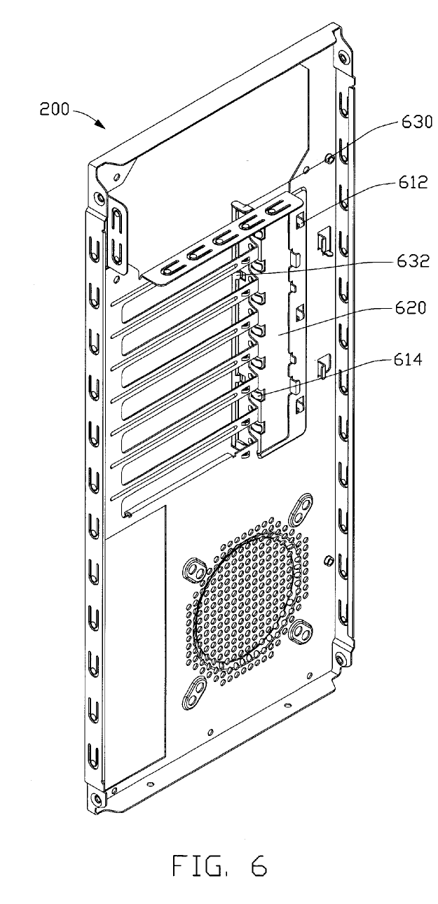

Please referring to FIGS. 4-6, the retainer 600 comprises a main body 610, a first side plate 620 perpendicularly, rightwards extending from a front edge of the main body 610, and a second side plate 630 bent forwardly from a rear edge of the main body 610, and having a U-shaped configuration. The first and second side plates 620, 630 are located at opposite sides of the main body 610, respectively. A pair of spaced first projections 632 extends forwardly from a front side of the second side plate 630 and bent inwardly towards the main body 610. A pair of second projections 612 is stamped from the main body 610 and bent outwardly towards the first projections 632, and aligned with the associated first projections 632, respectively. The first and second projections 632, 612 together form two pivot holes for receiving the pivot shafts 266 of the fixing plate 260. Therefore, the retainer 600 can be pivotally attached to the first back panel 200. Three latches 622 are formed near a right side edge of the first side plate 620 for extending through the associated through holes 278 of the first back panel 200 and the associated orifices 512 of the locking member 500 for detachably fixing the retainer 600 to the first back panel 200. A plurality of pressing fingers 614 are stamped from a joint portion of the main body 610 and the first side plate 620, and aligned with the corresponding first slots 230 of the first back panel 200.

In assembly, the locking member 500 is mounted to the first back panel 200 with the first and second tabs 272, 276 abuts against the associated flanges 520 of the locking member 500. The orifices 512 of the locking member 500 are aligned with the corresponding through holes 278 of the first back panel 200, respectively. The second slots 412 of the mounting cover 400 are aligned with the corresponding first slots 230 of the first back panel 200, respectively. The bent portion 420 of the mounting cover 400 extends through the elongated slot 250 and abuts against the fixing plate 260 with the holes 422 thereof snugly receiving the nubs 262 of the fixing plate 260, respectively. Simultaneously, the second walls 414 of the mounting cover 400 abut against the first walls 240 of the first back panel 200 with the notches 418 thereof snugly receiving the triangular protrusions 242 of the first walls 240 of the first back panel 200. Thus, the mounting cover 400 is mounted to the first back panel 200.

The slot cover 710 of each expansion card 700 is exposed in the associated first slot 230 of the first back panel 200 and the second slot 412 of the mounting cover 400. The head 720 of each expansion card 700 extends through the elongated slot 250 and abuts against the fixing plate 260 with the U-shaped pit 722 thereof snugly receiving the associated nub 262 of the fixing plate 260. Simultaneously, the splits 712 of the slot cover 710 snugly receive the elastic arms 416 of the second walls 414 of the mounting cover 400 therein.

The retainer 600 is pivoted about the fixing plate 260. The retainer 600 is pushed to pivot. The latches 622 of the retainer 600 slid into the associated through holes 278 of the first back panel 200 and the associated orifices 512 of the locking member 500, and engage with edges of orifices 512 of the locking member 500, whereby the retainer 600 is fixed to the first back panel 200. The pressing fingers 614 of the retainer 600 press the heads 720 of the corresponding expanding card 700, thereby fixing the expansion card 700 to the first back panel 200 and achieving an electrical connection between the heads 720 of the expansion cards 700 and the computer chassis. Thus, a computer chassis in accordance with the preferred embodiment of the present invention is achieved. In a same manner, the mounting cover 400, the locking member 500 and the retainer 600 can be mounted to the second back panel 300.

The motherboard holder 100, the first and second back panels 200, 300, the mounting board 400, the locking member 500 and the retainer 600 are available in two arrangements to make the computer chassis in accordance with the preferred embodiment of the present invention to be adapted to the ATX motherboard or the BTX motherboard.

When the computer chassis in accordance with the preferred embodiment of the present invention is adapted to the ATX motherboard: With respective to FIGS. 1-3, the first back panel 200 is mounted to the motherboard holder 100. The mounting board 400, the locking member 500 and the retainer 600 are mounted to the middle portion of the first back panel 200 in a manner as described above.

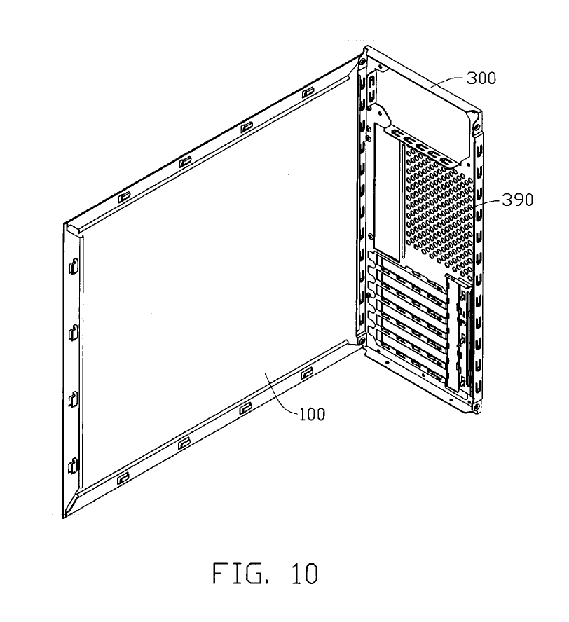

When the computer chassis in accordance with the preferred embodiment of the present invention is adapted to the BTX motherboard: With respective to FIGS. 10-12, the second back panel 300 is mounted to the motherboard holder 100. The mounting board 400, the locking member 500 and the retainer 600 are mounted to the bottom portion of the second back panel 300 in a manner similar to the mounting of the mounting board 400, the locking member 500 and the retainer 600 to the first back panel 200 which is described above.

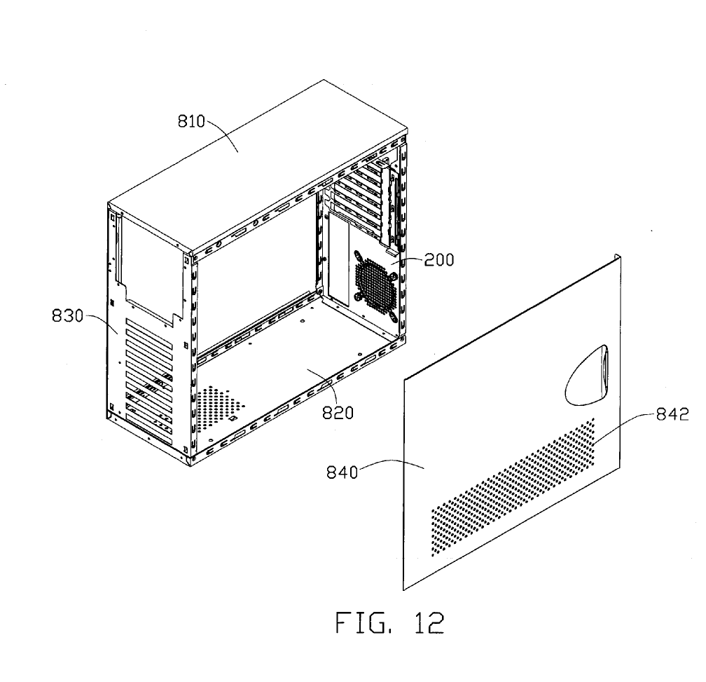

Referring to FIG. 12, a top panel 810, a bottom panel 820, a front panel 830, a side panel 840 and the computer chassis in accordance with the preferred embodiment of the invention together form a computer enclosure, which is adapted to an ATX motherboard. Remove the first back panel 200 away from the motherboard holder 100, and mount the second back panel 300 to the motherboard holder 100, the computer enclosure will be adapted to a BTX motherboard. In the computer enclosure, no matter the computer is adapted to ATX motherboard or BTX motherboard, the side panel 840 is disposed in a same side of the computer enclosure, i.e., a right side of the computer enclosure as seen from the front panel 830. The side panel 840 is located opposite the motherboard holder 100. Furthermore, the side panel 840 is removed from the computer enclosure when a user needs to access an inside of the computer enclosure to proceed with maintenance, replacement or repair of components in the computer enclosure. A plurality of vents 842 is provided in a lower portion of the side panel 840. The vents 842 are used to help enhancing heat dissipation effect of the computer enclosure no matter whether the computer enclosure is configured for an ATX motherboard or a BTX motherboard. Air flows into the inside of the computer enclosure through the vents when the fan (not shown) in the computer enclosure is activated to cool heat-generating electronic components in the computer enclosure.

The computer chassis in accordance with the preferred embodiment of the present invention is compatible with ATX and BTX motherboards. Computer chassis manufacturer can manufacture and sell the computer chassis in accordance with the present invention for ATX and BTX motherboards. When ATX motherboards become obsolete, the computer chassis in accordance with the present invention is still marketable.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A computer chassis compatible with an advanced technology extended (ATX) motherboard and a balanced technology extended (BTX) motherboard, comprising a motherboard holder for mounting an ATX motherboard or a BTX motherboard thereon, a first back panel designed for the ATX motherboard, and a second back panel designed for the BTX motherboard and a side panel, wherein the motherboard holder, the first and second back panels are available in two arrangements to make the computer chassis to be adapted to the ATX motherboard or the BTX motherboard, the side panel being located opposite the motherboard holder, the side panel defining a plurality of vents in a lower portion thereof.

2. The computer chassis as claimed in claim 1, wherein the first back panel comprises:
a rectangular window defined through the first back panel, and located at an upper portion thereof;
a plurality of first slots defined through the first back panel under the rectangular window in a middle portion thereof;
an opening defined through the first back panel located at a bottom potion thereof, under the first slots and adjacent to the motherboard holder when the first back panel is mounted to the motherboard holder;
a plurality of vents defined through the first back panel under the first slots and adjacent to the opening;
the second back panel comprises:
a rectangular window defined through the second back panel, and located at an upper portion thereof;
an opening defined through the second back panel, located in a middle portion thereof, under the rectangular window of the second back panel and adjacent to the motherboard holder when the second back panel is mounted to the motherboard holder;
a plurality of vents defined through the second back panel, under the rectangular window of the second back panel and adjacent to the opening of the second back panel;
a plurality of first slots defined through the second back panel located at a bottom portion thereof.

3. The computer chassis as claimed in claim 2, wherein the first back panel further comprises:
an elongated slot defined through the first back panel adjacent to ends of the first slots;
a fixing plate extending from a lateral edge of the elongated slot proximate to the first slots, the fixing plate comprising a plurality of nubs formed on a surface thereof, and a pair of spaced apertures defined in a rear side thereof to form two pivot shafts thereon;
a plurality of first walls formed between adjacent first slots, each having a triangular protrusion defined thereon;
the second back panel further comprises:
an elongated slot defined through the second back panel adjacent to ends of the first slots of the second back panel;
a fixing plate extending from a lateral edge of the elongated slot of the second back panel proximate to the first slots of the second back panel, the fixing plate of the second back panel comprising a plurality of nubs formed on a surface thereof, and a pair of spaced apertures defined in a rear side thereof to form two pivot shafts thereon;
a plurality of first walls formed between adjacent first slots of the second back panel, each having a triangular protrusion defined thereon.

4. The computer chassis as claimed in claim 3, wherein the first back panel further comprises at least one through hole defined through the first back panel; the second back panel further comprises at least one through hole defined through the second back panel.

5. The computer chassis as claimed in claim 4, further comprising a retainer adapted to being pivotably attached to one of the first and second back panels, respectively, the retainer comprising a main body, a first side plate perpendicularly extending from a side edge of the main body, and a second side plate bent from an opposite side edge of the main body.

6. The computer chassis as claimed in claim 5, wherein the retainer further comprises:
a pair of spaced first projections extending from a free side of the second side plate and bent towards the main body;
a pair of second projections stamped from the main body and bent towards the first projections, the first and second projections together forming two pivot holes for pivotably receiving the pivot shafts of the fixing plate of one of the first and second back panels;
at least one latch formed near an edge of the first side plate for extending through the associated through holes of one of the first and second back panels for detachably fixing the retainer to one of the first and back panels;
a plurality of pressing fingers stamped from a joint portion of the main body and the first side plate, and aligned with the corresponding first slots of the first and the second back panels.

7. The computer chassis as claimed in claim 6, wherein the first back panel further comprises:
a pair of first bent tabs formed on lateral edge of the elongated slot distant from the first slots thereof;
a pair of positioning protrusions formed between the first bent tabs;
a pair of second bent tabs aligned with the corresponding first bent tabs, respectively, extending from the first back panel proximate to an edge thereof; wherein the at least one through hole of the first back panel is located between the first and second bent tabs thereof;
the second back panel further comprises:
a pair of first bent tabs formed on a lateral edge of the elongated slot distant from the first slots thereof;
a pair of positioning protrusions formed between the first bent tabs of the second back panel;
a pair of second bent tabs aligned with the corresponding first bent tabs of the second back panel, respectively, extending from the second back panel proximate to an edge thereof; wherein the at least one through hole of the second back panel is located between the first and second bent tabs thereof.

8. The computer chassis as claimed in claim 7, further comprising a locking member adapted to being detachably mounted to one of the first and second back panels.

9. The computer chassis as claimed in claim 8, wherein the locking member comprises a board, a plurality of flanges perpendicularly extending from opposite ends of the board, and at least one orifice aligned with the at least one through hole of one of the first and second back panels, wherein when the locking member is mounted to one of the first and second back panels, the first and second tabs of one of the first and second back panels abut against the associated flanges of the locking member, respectively, and the at least one latch of the retainer extends through the at least one through hole of one of the first and second back panels and the at least one orifice of the locking member for engaging with an edge of the at least one orifice.

10. The computer chassis as claimed in claim 1, further comprising a mounting cover adapted to being detachably mounted to the first slots of the first and second back panels, respectively, the mounting cover is used for mounting expansion cards with slot covers to the first or the second back panels.

11. The computer chassis as claimed in claim 10, wherein the mounting cover comprises a body, and a bent portion perpendicularly extending from a side of the body, the body comprises a plurality of second slots and a plurality of second walls aligned with the corresponding first slots and first walls of one of the first and second back panels, respectively.

12. The computer chassis as claimed in claim 11, wherein each second wall comprises:
a plurality of elastic arms formed on an upper edge thereof for being retainingly received in splits defined in the slot cover of a corresponding expansion card;
a notch defined therein adjacent to the bent portion for receiving a corresponding triangular protrusion of one of the first and second back panels;
wherein the bent portion comprises a plurality of holes adjacent to the body of the mounting cover for receiving the nubs of the fixing plate of one of the first and second back panels.

13. A computer enclosure compatible with an ATX motherboard and a BTX motherboard, comprising:
a top panel, a bottom panel, a front panel, a side panel, a motherboard holder for mounting an ATX or BTX motherboard thereon, a first back panel designed for the ATX motherboard, and a second back panel designed for the BTX motherboard,
wherein the top panel, the bottom panel, the front panel, the side panel and the first and second back panels are available in two arrangements to form a computer enclosure adapted to the ATX motherboard or the BTX motherboard, respectively, the side panel being located opposite the motherboard holder and comprising a plurality of vents in a lower portion thereof.

14. The computer enclosure as claimed in claim 13, wherein the side panel is disposed at a right side of the computer enclosure as viewed from the front panel.

15. A computer enclosure comprising:
a front panel;
a motherboard holder extending rearwards from a first lateral side of the front panel;
a side panel extending rearwards from a second lateral side of the front panel opposite the first lateral side, the side panel having a plurality of holes therein, air flowing through the holes into an inside of the computer enclosure in order to cool electronic components in the computer enclosure;
wherein a rear side of the motherboard holder is selectively connected with a first type back panel for a motherboard having a first type of layout, and a second type back panel for a motherboard having a second type of layout.

16. The computer enclosure as claimed in claim 15, wherein the holes are defined in a lower portion of the side panel.

17. The computer enclosure as claimed in claim 15, wherein the motherboard having a first type of layout is an ATX motherboard, while the motherboard having a second type of layout is a BTX motherboard.

18. The computer enclosure as claimed in claim 17, wherein the first type back panel comprises:
a rectangular window defined through the first type back panel, and located at an upper portion thereof;
a plurality of first slots defined through the first type back panel, under the rectangular window, and in a middle portion of the first type back panel;
an opening defined through the first type back panel, located at a bottom potion of the first type back panel, and under the first slots and adjacent to the motherboard holder when the first type back panel is mounted to the motherboard holder; and
a plurality of vents defined through the first type back panel under the first slots and adjacent to the opening;
the second type back panel comprises:
a rectangular window defined through the second type back panel, and located at an upper portion thereof;
an opening defined through the second type back panel, located in a middle portion thereof, under the rectangular window of the second type back panel and adjacent to the motherboard holder when the second type back panel is mounted to the motherboard holder;
a plurality of vents defined through the second type back panel, under the rectangular window of the second type back panel and adjacent to the opening of the second type back panel;
a plurality of first slots defined through the second type back panel and located at a bottom portion thereof.
